(19) United States
(12) Patent Application Publication
(10) Pub. No.: US 2006/0064262 A1
(43) Pub. Date: Mar. 23, 2006

(54) Method and system for detecting a semiconductor manufacturing defect

(75) Inventors: Ju-Ching Chang, Kaohsiung City (TW); Pei Chao, Hsin-Chu County (TW); Shuenn Her Lee, Hsin-Chu County (TW); Cheng-Long Wu, Taipei City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Company, Ltd., Hsin-Chu (TW)

(21) Appl. No.: 10/945,127

(22) Filed: Sep. 20, 2004

(51) Int. Cl. G06F 19/00; G01N 37/00

(52) U.S. Cl. 702/84

(57) ABSTRACT

A method of semiconductor device defect analysis is provided. The method includes performing, by a first entity, a first defect analysis of a potential defect in a semiconductor device. The method also includes storing the first defect analysis in a potential defect database. The method further includes performing, by a second entity, a second defect analysis of the potential defect. The method still further includes determining if the first defect analysis is consistent with the second defect analysis.

### FIELD OF DISCLOSURE

The present disclosure relates generally to the field of semiconductor manufacturing and, more particularly, to a method and system for more efficiently detecting a defect during semiconductor manufacturing.

### BACKGROUND

The semiconductor integrated circuit (“IC”) industry has experienced rapid growth. Technological advances in IC materials and design have produced generations of ICs where each generation has smaller and more complex circuits than the previous generation. However, these advances have increased the complexity of processing and manufacturing ICs and, for these advances to be realized, similar developments in IC processing and manufacturing have been needed. For example, an IC is formed by creating one or more devices (e.g., circuit components) on a substrate using a fabrication process. As the geometry of such devices is reduced to the submicron or deep submicron level, the IC's active device density (i.e., the number of devices per IC area) and functional density (i.e., the number of interconnected devices per IC area) has become limited by the fabrication process.

Furthermore, as the IC industry has matured, the various operations for manufacturing an IC may be performed at different locations by a single company or by different companies that specialize in a particular area. This also increases the complexity of producing ICs, as companies and their customers may be separated not only geographically, but also by time zones, making effective communication more difficult. For example, a first company (e.g., an IC design house) may design a new IC, a second company (e.g., an IC foundry) may provide the processing facilities used to fabricate the design, and a third company may assemble and test the fabricated IC. A fourth company may handle the overall manufacturing of the IC, including coordination of the design, processing, assembly, and testing operations.

For IC manufacturers, detecting IC defects and communicating information about such defects, for example, with customers and engineers, is important. With previous techniques, IC manufacturers rely more on humans for detecting IC defects and communication of information about such defects. However, such techniques are less efficient and more likely to cause errors. Accordingly, what is needed is a method and system without the disadvantages described above.

### BRIEF DESCRIPTION OF THE DRAWINGS

FIG. 1 is a block diagram of a system according to the illustrative embodiment.

FIG. 2 is a more detailed block diagram of the system of FIG. 1.

FIG. 3 is a block diagram of representative one of computing system of FIG. 2.

FIG. 4 is a conceptual illustration of various processes performed by one or more of the computing systems of FIG. 2.

### DETAILED DESCRIPTION

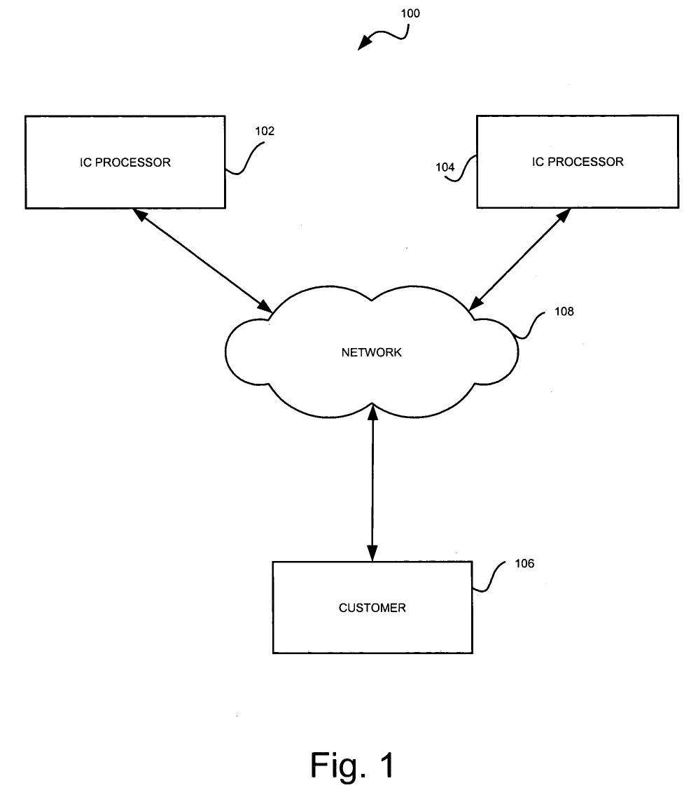

FIG. 1 is a block diagram of a system, indicated generally at 100 according to the illustrative embodiment. System 100 includes: (a) an integrated circuit (“IC”) processor 102, (b) an IC processor 104, and (c) a customer 106. The IC processor 102 is a semiconductor device (e.g., IC or wafer) design/fabrication company, and the IC processor 104 is an IC testing/packaging company. Accordingly, the IC processor 102 designs and fabricates IC's, and IC processor 104 tests and packages the IC's for delivery to a customer (e.g., the customer 106). The customer 106 is a purchaser of the IC's designed/fabricated by the IC processor 102 and tested/packaged by the IC processor 104.

In alternative embodiments, processes performed by each of the IC processors 102 and 104, differs from the above description. For example, in a first alternative embodiment, the IC processor 102 performs all of the processes (i.e., design, fabricate, test, and package) of IC manufacturing. In a second alternative embodiment, the IC processor 104 performs all such processes. In a third alternative embodiment, the IC processor 102 designs IC's and the IC processor 104 contributes to the manufacturing processes by fabricating, testing, and packaging the IC's.

Referring again to the illustrative embodiment depicted in FIG. 1, each of the IC processor 102, the IC processor 104, and the customer 106 includes one or more respective computing systems. Also, each of the computing systems of the IC processor 102, the IC processor 104, and the customer 106 includes a respective information handling system (“IHS”), such as a personal computer, a persona digital assistant, a pager, or a cellular phone.

Moreover, the system 100 includes a network 108 (e.g., a Transport Control Protocol/Internet Protocol (“TCP/IP”), such as the Internet or an intranet). Accordingly, each of computing systems of the IC processor 102, the IC processor 104, and the customer 106 is equipped with a respective network interface for communicating with the network 108.

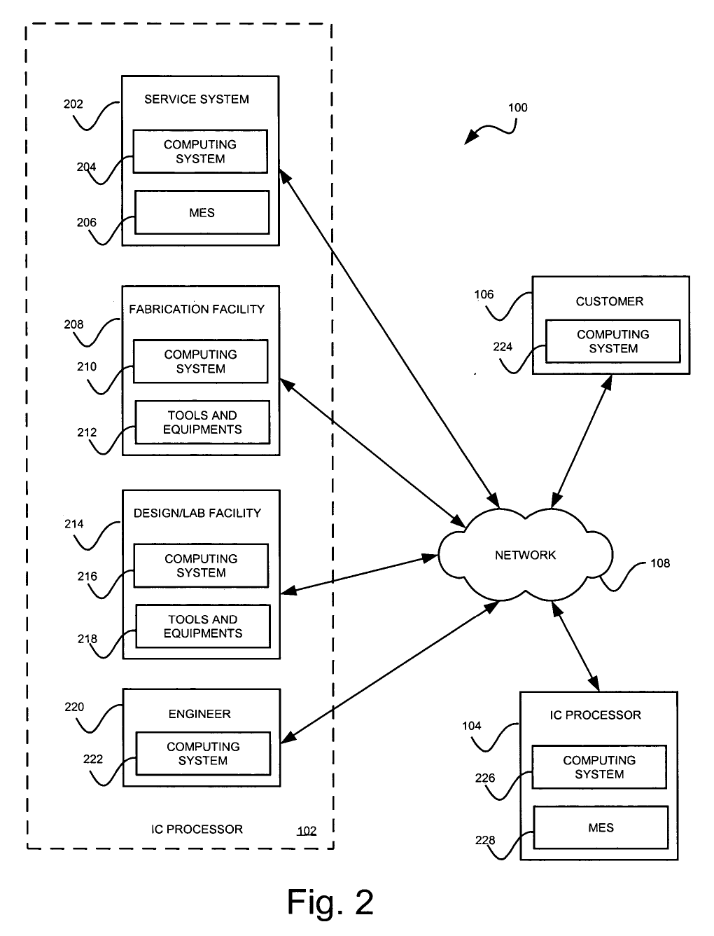

FIG. 2 is a more detailed block diagram of the system 100 of FIG. 1. As shown, the IC processor 102 includes the following entities: a service system 202, a fabrication facility 208, a design/lab facility 214, and an engineering system 220. Each of the entities 202, 208, 214, and 220 includes a respective computing system, and is coupled to one another, to the customer 106, and the IC processor 104 via the network 108. For communicating with the network 108, and with other entities, each of the entities includes a respective network interface (e.g., in association with the respective computing systems). Each of the entities is discussed in more detail below.

The service system 202 is an interface between a customer (e.g., the customer 106) and the IC processor 102, for communicating information about manufacturing operations. For facilitating such communication, the service system 202 includes a computing system 204. The service system 202 also includes a manufacturing execution system (“MES”) 206.

The MES 206 is a distributed computing system including one or more IHS's and one or more software applications. The MES 206 performs various operations to facilitate manufacturing of IC's. For example, the MES 206 collects various real-time information, organizes and stores the information in a centralized database, manages work orders, manages workstations, manages manufacturing processes, tracks inventory, and manages relevant documents. For performing the operations discussed above, the MES 206 is coupled to other systems and entities of the system 100.

The MES 206 is implemented by utilizing one or more of several commercially available products. Such commercially available products include Promis (Books Automations Inc. of Massachusetts), Workstream (Applied Materials, Inc. of California), Poseidon (IBM Corporation of New York), and Mirl-MES (Mechanical Industry Research Laboratories of Taiwan). Each of these products is commonly used for one or more specific applications within the semiconductor manufacturing industry. For example, Mirl-MES is often used in applications involving packaging, liquid crystal displays (“LCD's”), and printed circuit boards (“PCB's”). Promis, Workstream, and Poseidon are often used in IC fabrication and thin film transistor (“TFT”) LCD applications.

The fabrication facility 208 is for fabrication of IC's. Accordingly, the fabrication facility 208 includes fabrication tools and equipment 212. For example, the tools and equipment 212 include an ion implantation tool, a chemical vapor deposition tool, a thermal oxidation tool, a sputtering tool, various optical imaging system, and software for controlling the various tools and equipments. The fabrication facility 208 also includes a computing system 210.

The design/lab facility 214 is for designing and testing of IC's. The design/lab facility 214 includes design/test tools and equipment 218. The tools and equipment 218 include one or more software applications and hardware systems. Similar to other entities discussed above, the design/lab facility 214 includes a computing system 216.

The engineer 220 collaborates in the IC manufacturing process with other entities (e.g., the service system 202, or other engineers). For example, the engineer 220 collaborates with other engineers and the design/lab facility 214 for designing and testing IC's, monitors fabrication processes at the fabrication facility 208, and receives information regarding runs and yields. In at least one embodiment, the engineer 220 also communicates directly with the customer 106. In performing its various operations, the engineer 220 utilizes a computing system 222.

Similar to each of the entities of the IC processor 102, the customer 106 includes a computing system 224. Likewise, the IC processor 104 also includes a computing system 228. The IC processor 104 further includes a MES 228, which performs operations that are substantially similar to those performed by the MES 206 of the IC processor 102. However, the MES 228 performs such operations in the context of the processes (i.e., processes associated with testing and packaging) performed by the IC processor 104.

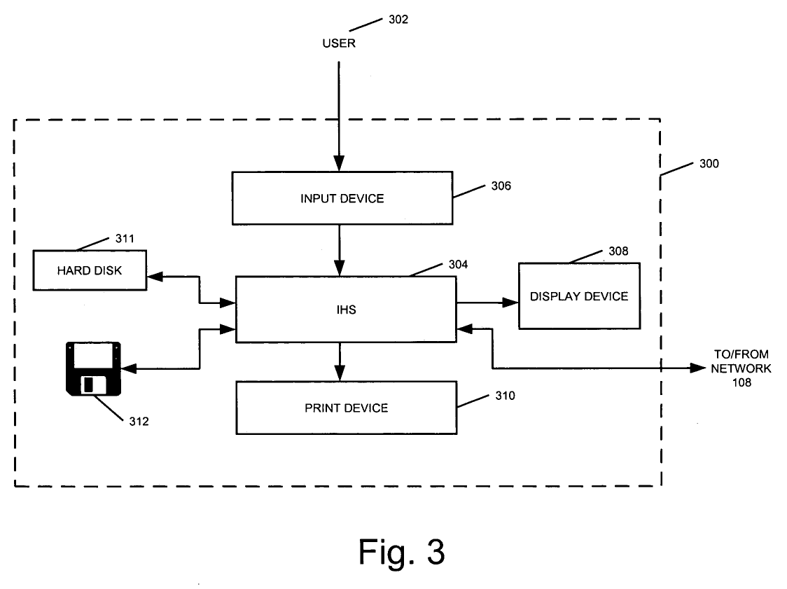

FIG. 3 is a block diagram of a representative one of the computing systems of FIG. 2. Such representative computing system is indicated by a dashed enclosure 300. Each of the computing systems of FIG. 2 operates in association with a respective human user. Accordingly, in the example of FIG. 3, the computing system 300 operates in association with a human user 302, as discussed further below.

As shown in FIG. 3, the computing system 300 includes (a) input devices 306 for receiving information from human user 302, (b) a display device 308 (e.g., a conventional electronic cathode ray tube (“CRT”) device) for displaying information to user 302, (c) an IHS 304 for executing and otherwise processing instructions, (d) a print device 310 (e.g., a conventional electronic printer or plotter), (e) a nonvolatile storage device 311 (e.g., a hard disk drive or other computer-readable medium (or apparatus), as discussed further below) for storing information, (f) a computer-readable medium (or apparatus) 312 (e.g., a portable floppy diskette) for storing information, and (g) various other electronic circuitry for performing other operations of the computing system 300.

For example, the IHS 304 includes (a) a network interface (e.g., circuitry) for communicating between the IHS 304 and the network 108 and (b) a memory device (e.g., random access memory (“RAM”) device and read only memory (“ROM”) device) for storing information (e.g., instructions executed by the IHS 304 and data operated upon by the IHS 304 in response to such instructions). Accordingly, the IHS 304 is connected to the network 108, the input devices 306, the display device 308, the print device 310, the storage device 311, and the computer-readable medium 312, as shown in FIG. 3.

Also for example, in response to signals from the IHS 304, the display device 308 displays visual images, and the user 302 views such visual images. Moreover, the user 302 operates the input devices 306 in order to output information to the IHS 304, and the IHS 304 receives such information from the input devices 306. Also, in response to signals from the IHS 304, the print device 310 prints visual images on paper, and the user 302 views such visual images.

The input devices 306 include, for example, a conventional electronic keyboard and a pointing device such as a conventional electronic “mouse”, rollerball or light pen. The user 302 operates the keyboard to output alphanumeric text information to the IHS 304, and the IHS 304 receives such alphanumeric text information from the keyboard. The user 302 operates the pointing device to output cursor-control information to the IHS 304, and the IHS 304 receives such cursor-control information from the pointing device.

Referring again to FIG. 2, for IC processors 102 and 104, detection of defects in IC's during manufacturing is important, as discussed above. Semiconductor IC manufacturing is relatively cost-sensitive and involves relatively expensive equipment and facilities. Increasing manufacturing yield is a technique for managing costs associated with IC manufacturing. The technique as it relates to this discussion for increasing manufacturing yield includes detecting defects in IC's and prescribing subsequent actions to prevent future defects in subsequently manufactured IC's. Thus, a more efficient technique to detect an IC defect and initiate subsequent remedial actions in response to such a defect is needed. Also, it is desirable that such technique allows for outputting information about the defect to customers and other users (e.g., engineers).

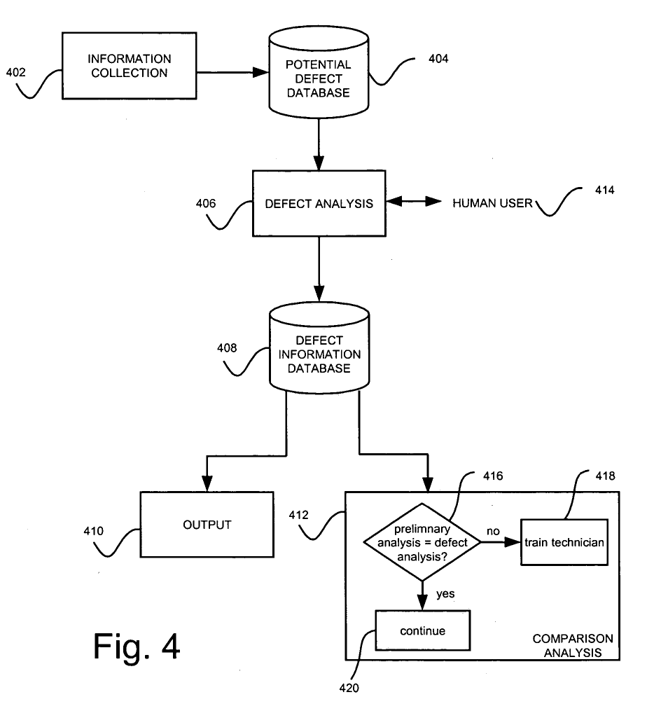

Accordingly, FIG. 4 is a conceptual illustration of various processes executed by one or more of the computing systems of FIG. 2. For an explanatory purpose, the following discussion references the computing system 210 as executing such processes, although in at least one other embodiment, any one or more the computing systems of FIG. 2 are equipped to execute such processes. As shown in FIG. 4, the computing system 210 executes an information collection process 402, a defect analysis process 406, an output process 410, and a comparison analysis process 412.

By executing the information collection process 402, the computing system 210 receives information about a potentially defective semiconductor IC. Such information includes a visual image (e.g., a visual image of a microscope inspection) showing the structure of the IC. A technician generates the information, for example, by “capturing” an image of the potentially defective IC using a microscope. The technician also performs a preliminary analysis of the image, and attaches a result (e.g., indicating the type of defect) of the analysis to the image. Accordingly, the information about the potentially defective IC includes the image and the result of the technician's preliminary analysis. In addition, the information includes the IC's identifying information, such as the IC's lot information. The technician outputs the information about the potentially defective IC to the computing system 210. In response to receiving the information, the computing system 210 stores the information in a potential defects database 404 as shown in FIG. 4. In this way, the computing system 210 stores the image of the potentially defective IC contemporaneously with storing the result of the preliminary analysis.

By executing the defect analysis process 406, the computing system 210 performs a more detailed defect analysis in response to the information stored in the database 404 and an input from a human user 414. The human user 414 is an engineer, and performs an engineer analysis of the information about the potentially defective IC. The human user 414 performs such engineer analysis in response to the information and also in response to comments from one or more other human users, such as other engineers, and/or the engineer's manager. In an alternative embodiment, the human user 414 performs the engineer analysis in response to only the information stored in the potential defects database 404, without the comments from the other human user.

The human user 414 inputs a result of the engineer analysis to the computing system 210, and the computing system 210 receives the result. Moreover, in response to the information stored in the potential defects database 404 and the result of the engineer analysis discussed above, the computing system 210 performs the defect analysis 406 to determine the potentially defective IC's defect information, including whether (a) the potentially defective IC is actually determined to be defective, (b) if so, the nature (e.g., type) of the defect, and (c) a subsequent action. In an alternative embodiment, by executing the defect analysis 406, the computing system merely substitutes the result of the engineer analysis for its own analysis.

A purpose of the subsequent action is to reduce reoccurrence of defects that are similar or identical to the defect detected in the IC discussed above. Accordingly, examples of subsequent actions include revising or adjusting recipes, equipment parameters, and any other factors associated with IC processing.

As shown in FIG. 4, the computing system 210 stores the defect information in a defect information database 408, and for each defective IC, the defect information database 408 is organized to include a record of such defect information. The defect information stored in the defect information database 408 is utilized in the output process 410 and the comparison analysis process 412.

By executing the output process 410, the computing system 210 outputs to a customer (e.g., the customer 106) or an engineer, the defect information associated with an IC. Such outputting is performed using one or more standard communication protocols (e.g., HTTP). In the illustrative embodiment, the computing system 210 outputs the defect information in response to receiving a query from the customer or the engineer. However, in an alternative embodiment, the computing system 210 outputs the defect information in response to a predetermined schedule, thereby keeping the customer or the engineer regularly updated on defect status of the IC. In yet another embodiment, the computing system 210 outputs the defect information in response to both a query and a predetermined schedule.

By executing the comparison analysis 412, the computing system 210 determines whether the technician performing the preliminary analysis discussed above, should be trained. As shown in a decision block 416, in making the determination, the computing system determines whether the result of the technician's preliminary analysis is equal to or substantially equal to the result of the defect analysis 406. If so, the computing system 210 continues with its normal operation as indicated by a step 420. However, if it determines otherwise, the computing system 210 outputs a signal indicating (or recommending) that the technician should be trained as indicated by a step 418.

Although illustrative embodiments have been shown and described, a wide range of modification, change, and substitution is contemplated in the foregoing disclosure and, in some instances, some features of the embodiments may be employed without a corresponding use of other features. Accordingly, broad constructions of the appended claims in manner consistent with the scope of the embodiments disclosed are appropriate.

What is claimed is:

1. A method of semiconductor device defect analysis comprising:
performing, by a first entity, a first defect analysis of a potential defect in a semiconductor device;
storing the first defect analysis in a potential defect database;
performing, by a second entity, a second defect analysis of the potential defect; and
determining if the first defect analysis is consistent with the second defect analysis.

2. The method of claim 1, wherein the first entity exhibits a first level of experience.

3. The method of claim 2, wherein the second entity exhibits a second level of experience which is greater then the first level of experience.

4. The method of claim 1 including storing the second defect analysis in a defect information database.

5. The method of claim 1 including recommending that the first entity be given additional training if the first defect analysis is not consistent with the second defect analysis.

6. The method of claim 1 including storing a potential defect image in the potential defect database contemporaneously with storing the first defect analysis.

7. The method of claim 1 including initiating a subsequent action in response to the second defect analysis.

8. The method of claim 1, wherein the potential defect is indicated by a visual image of the semiconductor device.

9. The method of claim 1 including outputting the second defect analysis to a user.

10. The method of claim 9, wherein the user is a customer.

11. The method of claim 9, wherein the user is an engineer.

12. The method of claim 9, wherein outputting the second defect analysis to a user is by outputting through a global computer network.

13. The method of claim 12, wherein outputting through the global computer network is by outputting using the Hyper Text Transfer Protocol (“HTTP”).

14. A system of semiconductor device defect analysis comprising:
an information handling system (“IHS”) for:
receiving a first defect analysis of a potential defect in a semiconductor device;
storing the first defect analysis in a potential defect database;
performing a second defect analysis of the potential defect; and
determining if the first defect analysis is consistent with the second defect analysis.

15. The system of claim 14, wherein the first defect analysis is performed by a first entity exhibiting a first level of experience.

16. The system of claim 15, wherein performing the second defect analysis is in response to an analysis performed by a second entity exhibiting a second level of experience which is greater then the first level of experience.

17. The system of claim 14, wherein the IHS is further for storing the second defect analysis in a defect information database.

18. The system of claim 14, wherein the IHS is further for outputting a signal recommending that the first entity be given additional training if the first defect analysis is not consistent with the second defect analysis.

19. The system of claim 14, wherein the IHS is further for storing a potential defect image in the potential defect database contemporaneously with storing the first defect analysis.

20. The system of claim 14, wherein the IHS is further for outputting a signal indicating a subsequent action in response to the second defect analysis.

21. The system of claim 14, wherein the potential defect is indicated by a visual image of the semiconductor device.

22. The system of claim 14, wherein the IHS is further for outputting the second defect analysis to a user.

23. The system of claim 22, wherein the user is a customer.

24. The system of claim 22, wherein the user is an engineer.

25. The system of claim 22, wherein outputting the second defect analysis to a user is by outputting through a global computer network.

26. The system of claim 25, wherein outputting through the global computer network is by outputting using the Hyper Text Transfer Protocol (“HTTP”).
